(19) United States
(12) Patent Application Publication
(10) Pub. No.: US 2011/0064266 A1
(43) Pub. Date: Mar. 17, 2011

(54) DEVICE AND METHOD FOR CHECKING CONTAINER CLOSURES

(75) Inventor: THOMAS ZECH, Donaustauf (DE)

(73) Assignee: KRONES AG, Neutraubling (DE)

(21) Appl. No.: 12/879,051

(22) Filed: Sep. 10, 2010

(30) Foreign Application Priority Data
Sep. 11, 2009 (DE) 102009041212.3

(51) Int. Cl. G06K 9/00; B65G 47/34; B65G 43/00

(52) U.S. Cl. 382/100; 198/339.1; 198/341.01

(57) ABSTRACT

A method for checking container closures with a checking means, including passing the container closures by the checking means by means of a conveyor medium without isolating the container closures upstream of the checking means, and checking the container closures with the checking means.

### CROSS-REFERENCE TO RELATED APPLICATION

The present application claims the benefit of priority of German Application No. 102009041212.3, filed Sep. 11, 2009. The entire text of the priority application is incorporated herein by reference in its entirety.

### FIELD OF THE DISCLOSURE

The present disclosure relates to a device and a method for checking container closures with a checking means, such as for beverage bottling operations.

### BACKGROUND

In the beverage industry, block machines which consist of several individual machines for certain jobs are often employed. The efficiency of such a system corresponds to the product of the efficiencies of the individual machines.

A disadvantage of such a block machine is that it might be necessary to stop the complete system if a problem occurs in an individual machine. This reduces the efficiency of the complete system and can lead to the loss of raw material if a treatment process cannot be stopped.

One possible source of errors is that fed materials, for example raw, process or operating materials, are defective as their quality is often poorer to save costs.

For example, a block machine can comprise a filling system and a closing system. In the closing system, container closures are used to air-tightly close containers after they have been filled. Usually, about 1% to 2% of the container closures are defective or faulty.

Due to defective container closures, problems can arise during closing. To prevent this, a device is used in prior art which identifies faulty container closures and removes them from the process flow by means of a discharging means. Such a device and a corresponding method are known, for example, from US 2009/0107896.

In prior art, the container closures are pulled apart or isolated upstream of the checking means. Thereby, the container closures are passed by the checking means individually and separated from each other.

This, however, has a disadvantage in that additional mechanical elements must be provided to separate the container closures that are conveyed lying close to each other upstream of the checking means, and to pack them again afterwards. These additional mechanical elements are not only cost-intensive, but they are also potentially susceptible to defects or malfunctions.

### SUMMARY OF THE DISCLOSURE

It is therefore one aspect of the present disclosure to provide a facilitated method and a facilitated device for checking container closures with a checking means.

The method according to the disclosure for checking container closures with a checking means comprises the steps of passing the container closures by the checking means by means of a conveyor medium without isolating the container closures upstream of the checking means, and checking the container closures with the checking means.

Due to the fact that the container closures are not isolated upstream of the checking means, the method can be facilitated compared to prior art. In the course of the isolation of the container closures, it is often necessary in prior art to pass the container closures by the checking means at a higher speed. As in the present disclosure, the container closures are not isolated, the container closures can be passed by the checking means at a reduced speed, compared to prior art.

The checking of the container closures can be accomplished in particular in line. In other words, no separating elements or baffles for isolating the closures are required. Without isolating can in particular mean that the container closures are not spaced apart or separated in addition or for checking purposes.

The container closures can be in particular bottle closures. The container closures can comprise plastics and/or metal. The container closures can be screw caps, crown caps, flat caps or sport caps.

The container closures can be arranged on the conveyor medium directly lying next to each other.

The container closures can be passed by the checking means one behind the other. In other words, the container closures can be arranged in a row on the conveyor medium. The container closures can be passed by the checking means on the conveyor medium in particular rightly or directly lying next to each other.

The container closures can be passed by the checking means under back pressure. Back pressure means the pressure on one container closure by one or several container closures following in the conveying direction.

The container closures can be orientated horizontally while they pass by the checking means. In other words, the conveyor medium can be arranged horizontally, and the container closures can be passed by the checking means horizontally.

The container closures can be guided laterally during checking. In other words, at least in the region of the checking means, a guide element for laterally guiding the container closures can be provided.

The container closures can be passed by the checking means such that the container closures touch each other directly or rightly, or that the distance between two container closures is much smaller than the radius of a container closure, in particular where the distance between two container closures is smaller than or equal to ½, ⅓, ¼, ⅕, ⅙, 1/7, ⅛, 1/9, 1/10, 1/50 or 1/100 of the radius of a container closure.

The checking means can in particular be an inspection means. The checking means can comprise one or several optoelectronic sensors, in particular a camera.

The checking means can comprise a camera, where the checking step comprises the generation of an in particular digital picture of a container closure. The camera can be in particular a CCD-camera. The checking means can moreover comprise a lighting element for lighting the container closures or the container closure to be checked.

The checking means can moreover comprise an evaluation element, in particular a computer, wherein the checking step comprises an evaluation of the picture of the container closure with the evaluation element. Thereby, the check or inspection of the container closures can be carried out all-automatically.

The evaluation element can in particular evaluate or analyze optical and/or geometric properties of a container closure. The optical properties can comprise, for example, the color and/or the reflectivity of the container closure. The geometric properties can comprise the shape of the container closure, in particular the size (dimensions), the eccentricity and/or the symmetry of the container closure. The evaluation element can compare the actual state of a container closure with a predetermined desired state. The evaluation element can be configured to determine or detect defective sites of a container closure by means of the picture.

The evaluation of the picture can comprise the determination of the centre of a container closure in the picture to be evaluated. In particular, the evaluation of the picture can comprise centering a pictured container closure from the inside to the outside. As the container closures are passed by the checking means lying directly next to each other, a picture of a container closure can also comprise further container closures and/or parts of further container closures. By centering a container closure from the inside to the outside, evaluation can be better restricted to an individual container closure.

The checking step can comprise the determination of defective or faulty container closures. The checking step can comprise the determination of non-workable container closures. Non-workable container closures can be, for example, container closures of a different type or with different properties, for example different color, with respect to the correct or workable container closures.

The method can moreover comprise the sorting out of defective or faulty and/or non-workable container closures. In other words, the method can comprise the determination of faulty container closures and/or correct or usable container closures, and the separation of the faulty container closures from the usable container closures.

For sorting out a faulty container closure, a discharge element can be used, for example a mechanical arm or a nozzle to act on the faulty container closure with compressed air.

The step of sorting out can comprise stopping the conveyor medium or the stream of container closures. Thereby, the discharge operation can be facilitated. In particular, the stream of container closures or the stream of closures can be stopped for the step of sorting out, in particular by a stopping means which is arranged upstream of the checking means with respect to the conveying direction of the conveyor medium.

The stream of closures can be stopped in particular immediately or directly when the checking means detects a faulty and/or non-workable container closure.

The step of sorting out can moreover comprise sorting out one or several adjacent container closures at the container closure detected to be defective or faulty and/or non-workable. Thereby, one can in a facilitated manner ensure that the faulty container closure has been sorted out. For example, all container closures arranged between the stopping means and the checking means when the stream of closures was stopped can be sorted out.

The above-described method can also be used for checking other objects used in the beverage industry, for example empty nonreturnable bottles.

The disclosure moreover provides a device for checking container closures, in particular to be used with a method as described above, comprising a checking means and a conveyor medium, wherein the device is designed such that container closures are passed by the checking means on the conveyor medium without isolating them.

The device can comprise one or several ones of the above-described features. In particular, the device can comprise a checking means or an inspection means, an evaluation element, in particular a computer, a stopping means and/or a discharge element.

The conveyor medium can comprise modular belts. The conveyor medium can correspond to a slat-band chain conveyor or a belt conveyor, or it can be comprised in a slat-band chain conveyor or a belt conveyor. The conveyor medium can comprise belt ribbons. The conveyor medium can be a conveyor belt.

The device can be in particular arranged in the conveying direction of the container closures downstream of an apparatus for providing container closures. The apparatus for providing container closures can be designed such that container closures are arranged in a predetermined or desired orientation on the conveyor medium of a device described above.

The disclosure moreover provides a method for removing faulty objects from a sequence of objects for objects in the beverage industry, in particular container closures, comprising checking the objects with the checking means, comprising passing the objects by the checking means by means of a conveying medium, and if the checking means detects a faulty and/or non-workable object, stopping the stream of objects upstream of the checking means by means of a stopping means, and sorting out the faulty and/or non-workable object by means of a discharge element, in particular sorting out all objects arranged between the stopping means and the discharge element after the stream of objects has been stopped.

The sequence of objects or the amount of objects can in particular correspond to a sequence of objects used in the beverage industry, for example empty nonreturnable bottles or container closures. The stream of objects can correspond to the sequence moved on the conveyor medium or to a moved partial sequence of the sequence.

The step of passing by and/or the step of checking can be performed in particular as described above. In particular, the objects can be passed by the checking means without being isolated. The objects can be container closures.

The determination of a faulty and/or non-workable object can be performed as described above for the case of a container closure.

The stopping of the stream of objects can be accomplished directly or immediately after the detection or determination of a faulty object by the checking means.

The stopping means can in particular comprise a bolt or stop bolt, wherein the stopping step comprises an at least partial arrangement of the stop bolt, so that the stream of objects is stopped. The stop bolt can be in particular introduced into the stream of objects, so that the movement of the objects is blocked in the conveying direction.

The stop bolt can be designed, for example, cylindrically, conically or rectangularly.

The discharge element or guiding-out element can be, for example, a mechanical arm or a nozzle to act on the faulty container closure with compressed air.

The method can moreover comprise a determination of the discharge time, wherein the discharge time corresponds to the time required for sorting out one or several, in particular all, objects arranged between the stopping means and the discharge element after the stream of objects has been stopped. The guiding-out time can be determined based on the conveying speed of the conveyor medium.

The guiding-out time can be optimized based on the minimal and/or maximal conveying speed of the conveyor medium. For example, the point in time at which the object determined as being faulty and/or non-workable is passed by the discharge element can be determined. The discharge element can then be actuated such that the faulty and/or non-workable object is sorted out. In particular, the discharge element can be actuated such that also one or several objects adjacent to the object determined as being faulty and/or non-workable are sorted out.

The method can moreover comprise starting the stream of objects after the step of sorting out.

The disclosure moreover provides a device for removing faulty objects from a sequence of objects for objects in the beverage industry, in particular container closures, in particular to be used with an above-described method for removing faulty objects, comprising a checking means, a conveyor medium, a stopping means arranged in the conveying direction of the conveyor means upstream of the checking means, and a discharge element arranged in the conveying direction of the conveyor medium downstream of the checking means, wherein the device is configured such that, if the checking means detects a faulty or non-workable object, stopping of the stream of objects upstream of the checking means by means of the stopping means and sorting out of the faulty and/or non-workable object by means of a discharge element, in particular sorting out of all objects arranged between the stopping means and the discharge element after the stream of objects has been stopped, take place.

### BRIEF DESCRIPTION OF THE DRAWINGS

Further features and advantages will be described below with reference to the exemplary figures. In the drawings:

FIG. 1 shows an illustration of an exemplary device for checking container closures in a side view;

FIG. 2 shows an illustration of an exemplary device for checking container closures in a plan view; and

FIG. 3 shows an illustration of an exemplary device for removing faulty container closures in a plan view.

### DETAILED DESCRIPTION OF THE PREFERRED EMBODIMENT

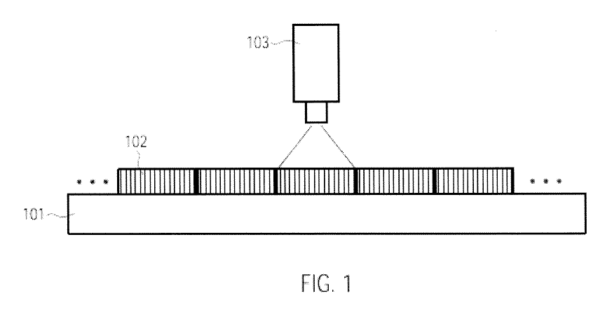

FIG. 1 illustrates a device for checking container closures with a checking means. This exemplary device can be used in particular for a method for checking container closures with a checking means.

FIG. 1 shows a conveyor medium 101, for example a conveyor belt, on which container closures 102 are arranged lying directly one next to the other. The container closures 102 are passed or moved by the checking means 103 lying directly one next to the other. The checking means 103 can in particular comprise a camera, which generates pictures, in particular digital pictures, of the container closures 102 passed by.

In FIG. 1, the container closures 102 touch or contact each other directly or rightly and are passed by the checking means 103 one behind the other or sequentially. In other words, a back pressure acts on each container closure 102 from one or several adjacent container closures, in particular container closures 102 preceding in the conveying direction.

The checking means 103 can be in particular used to determine defective or faulty container closures. For this, the checking means 103 can comprise an evaluation element, for example a computer, for evaluating a picture of a container closure.

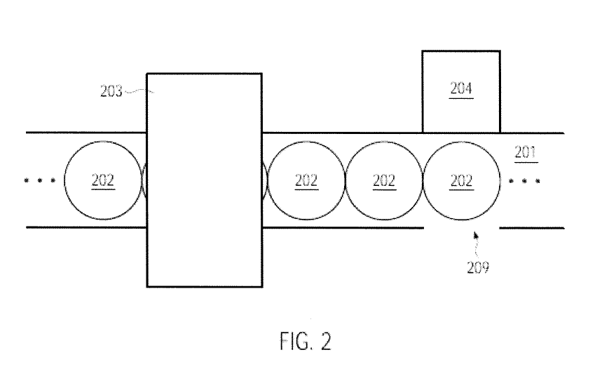

FIG. 2 shows a device by way of example for checking container closures with a checking means, e.g. as that of FIG. 1, in a plan view. For example, in FIG. 2 a conveyor medium 201 and container closures 202 arranged thereon directly lying next to each other are shown. Moreover, FIG. 2 shows a checking means 203 at which the container closures 202 are passed or moved by one behind the other or sequentially.

The container closures 202 touch each other, that means, they are passed by under the checking means 203 under back pressure. As an alternative, the distance between two container closures can be much smaller than the radius of a container closure.

The container closures 202 can be, for example, screw caps, crown caps, flat caps or sport caps.

FIG. 2 moreover shows a discharge element 204, the discharge element 204 being arranged in the conveying direction downstream of the checking means 203 and designed such that it can remove defective or faulty and/or non-workable container closures from the processing operation. The discharge element 204 can in particular comprise a mechanical arm which can push a faulty container closure down from the conveyor medium 201. As an alternative or in addition, the discharge element 204 can comprise a nozzle which can act on a faulty container closure with compressed air and thereby remove the faulty container closure from the conveyor medium 201. Moreover, a discharge possibility or a discharge path 209 is shown via which a removal of a faulty container closure is possible. The discharge path 209 can, for example, correspond to an opening in a possibly existing lateral guide rail or a discharge plate.

The conveyor medium 201 can be stopped if a defective or faulty container closure has been determined. Thereby, sorting out of the faulty container closure can be facilitated. In particular, less mechanics and/or electronics can be used thereby than in sorting out without stopping the conveyor medium. This is less expensive and potentially fault-prone mechanics and/or electronics can be omitted. For example, a vacuum belt, which would be otherwise necessary due to air swirls during guiding out or sorting out, can then be omitted by stopping the stream of container closures.

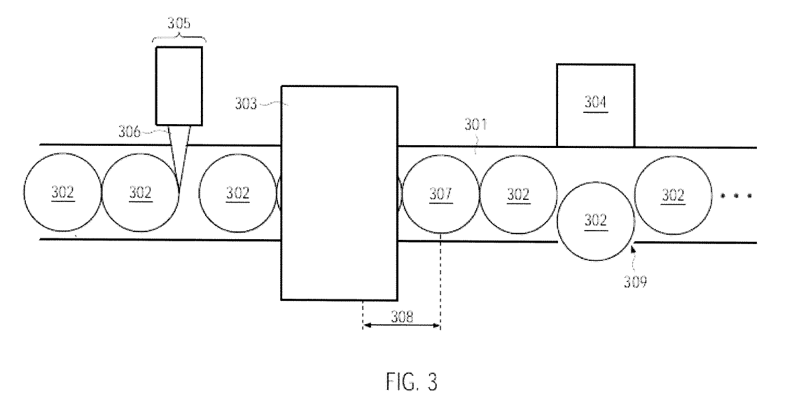

In FIG. 3, an illustration of an exemplary device for removing faulty container closures is shown in a plan view. This exemplary device can be used in particular for a method for removing faulty container closures. Basically, the method can also be applied to other objects in the beverage industry, for example empty nonreturnable bottles or the like.

In particular, FIG. 3 shows a conveyor medium 301 on which container closures 302 are passed by a checking means 303. Downstream of the checking means 303, a discharge element 304 is arranged, and upstream of the checking means 303, a stopping means 305 is arranged. The terms upstream and downstream here refer to the conveying direction of the conveyor medium which in this example, as in the FIGS. 1 and 2, runs from the left to the right. Moreover, FIG. 3 shows, analogously to FIG. 2, a discharge path 309.

As soon as the checking means 303 finds or detects a faulty or non-workable container closure 307, the stream of closures is immediately stopped by the stopping means 305. In particular, the stopping means 305 comprises a stop bolt 306 which can be arranged for stopping the container closures such that it blocks the movement of the container closures 302 in the conveying direction. During the evaluation time of the checking means 303, in particular the evaluation element, the container closures 302 move further by a section 308. To ensure that faulty container closures 307 can be sorted out, the distance of the discharge element 304 from the checking means 303 can be larger than the section 308 maximally covered within the evaluation time, i.e. at the maximal conveying speed.

To ensure that the faulty container closure 307 is sorted out, several adjacent container closures can also be sorted out, in particular all container closures arranged between the stopping means 305 and the discharge element 304 at the time of stopping.

Signal tracing, i.e. the tracing of the container closures by control, can be time-controlled and/or accomplished by a “first-in first-out” method. For example, for sorting out or discharging a faulty and/or non-workable container closure, the time at which the faulty and/or non-workable container closure is passed by the discharge element can be determined via the conveying speed of the conveyor medium, in particular via the minimal or maximal conveying speed. This method is referred to as time-controlled.

As an alternative, container closures can be counted and thus identified by means of several sensors, in particular at different positions along the conveying section. This method is referred to as “first-in first-out” method. If container closures are to be sorted out or removed from a sequence of container closures, however, a time-controlled method can be more advantageous.

It will be understood that features mentioned in the above described embodiments are not restricted to these special combinations and are also possible in any other combinations. In particular, the shown methods and devices can also be applied to other objects in the beverage industry, for example empty nonreturnable bottles or the like.

1. Method for checking container closures with a checking means, comprising:
passing the container closures by a checking means by means of a conveyor medium without isolating the container closures upstream of the checking means; and
checking the container closures with the checking means.

2. Method according to claim 1, wherein the container closures are, or can be, arranged on the conveyor medium directly lying next to each other.

3. Method according to claim 1, and passing the container closures by the checking means on the conveyor medium one behind the other.

4. Method according to claim 1, and passing the container closures by the checking means in a horizontal orientation.

5. Method according to claim 1, and guiding the container closures laterally during checking.

6. Method according to claim 1, wherein the container closures touch each other directly or rightly, or the distance between two container closures is much smaller than the radius of a container closure.

7. Method according to claim 1, wherein the checking means comprises a camera, and wherein the checking step comprises the generation of a digital picture of a container closure.

8. Method according to claim 7, wherein the checking means further comprises an evaluation element, and wherein the checking step comprises an evaluation of the picture of the container closure with the evaluation element.

9. Method according to claim 8, wherein the evaluation of the picture comprises centering a pictured container closure from the inside to the outside.

10. Method according to claim 1, wherein the checking step comprises a determination of defective, faulty and/or non-workable container closures.

11. Method according to claim 10, further comprising sorting out defective, faulty and/or non-workable container closures.

12. Method according to claim 11, wherein the step of sorting out comprises stopping the conveyor medium.

13. Device for checking container closures, according to a method according to claim 1, comprising:
a checking means;
a conveyor medium; and
wherein the device is designed such that container closures are passed by the checking means on the conveyor medium without isolation.

14. Method for removing faulty objects from a sequence of objects for objects in the beverage industry, in particular container closures, comprising:
checking the objects with a checking means, comprising passing the objects by the checking means by means of a conveyor medium; and
if a faulty and/or non-workable object is detected by the checking means:
stopping the stream of objects upstream of the checking means by means of a stopping means; and
sorting out the faulty and/or non-workable object by means of a discharge element

15. Method according to claim 14, wherein the objects are container closures, and wherein the checking step corresponds to a method according to claim 1.

16. Method according to claim 3, wherein the conveyor medium is a conveyor belt.

17. Method according to claim 6, wherein the distance between two container closures is smaller or equal to ½, ⅓, ¼, ⅕, ⅙, 1/7, ⅛, 1/9, 1/10, 1/50 or 1/100 of the radius of a container closure.

18. Method according to claim 8, wherein the evaluation element is a computer.

19. Method according to claim 14, wherein sorting out comprises sorting out all objects arranged between the stopping means and the discharge element after the stream of objects has been stopped.
